(19) United States
(12) Patent Application Publication
(10) Pub. No.: US 2014/0089882 A1
(43) Pub. Date: Mar. 27, 2014

(54) COMPUTING DEVICE AND METHOD FOR MODULARIZING POWER SUPPLIES PLACED ON PCB

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHOU YANG, Shenzhen (CN); SONG-LIN TONG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/961,889

(22) Filed: Aug. 8, 2013

(30) Foreign Application Priority Data
Sep. 27, 2012 (CN) 2012103697225

(51) Int. Cl. G06F 17/50

(52) U.S. Cl. CPC G06F 17/5072
USPC 716/120

(57) ABSTRACT

In a method for modularizing power supplies placed on a printed circuit board (PCB) using a computing device, a circuit design drawing of a power supply is obtained from a database. The method acquires circuit design data of the power supply from the circuit design drawing of the power supply, and modularizes the circuit design data to generate a virtual power supply. The method generates a first layout of the virtual power supply on the PCB in a landscape orientation according to a horizontal dimension of the PCB, and generates a second layout of the virtual power supply on the PCB in a portrait orientation according to a vertical dimension of the PCB. A component information system (CIS) management library is created in the database, and the first layout and the second layout of the virtual power supply are stored in the CIS management library.

### BACKGROUND

1. Technical Field

Embodiments of the present disclosure relate to a printed circuit board (PCB) layout systems and methods, and particularly to a computing device and a method for modularizing power supplies placed on a PCB.

2. Description of Related Art

Electronic devices, such as computers and servers, may include one or more printed circuit boards (PCBs) that includes a plurality of electronic components, such as processors, memories, audio and video cards, and power supplies. Multiple electronic components may be placed on a PCB. The process of placing the electronic components, traces, and other board features on a PCB is generally referred to as PCB layout. However, different types of the power supplies placed on a PCB need different layouts of the PCB when the PCB is being manufactured. In the placement of the power supplies on the PCB, the placement may be performed manually, which may be complicated, inefficient, and costly. Therefore, there is room for improvement in the art.

### BRIEF DESCRIPTION OF THE DRAWINGS

FIG. 1 is a block diagram of one embodiment of a computing device including a power supply modularizing system.

FIG. 2 is a flowchart of one embodiment of a method for modularizing power supplies placed on a PCB using the computing device of FIG. 1.

FIG. 3 shows one embodiment of a circuit design drawing of a power supply.

FIG. 4 shows a first layout of the power supply placed on the PCB in a landscape orientation of the PCB.

FIG. 5 shows a second layout of the power supply placed on the PCB in a portrait orientation of the PCB.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

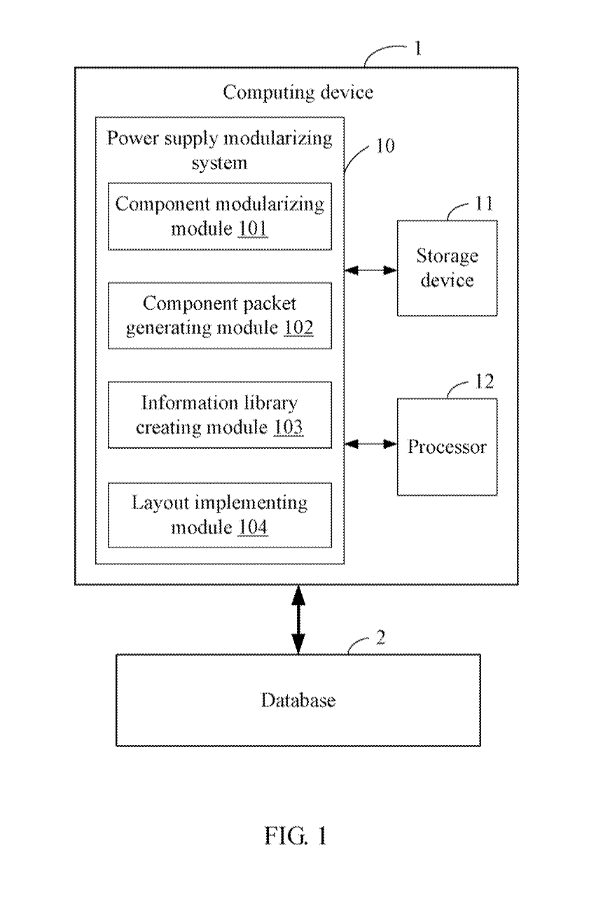

FIG. 1 is a block diagram of one embodiment of a computing device 1 including a power supply modularizing system 10. In the embodiment, the power supply modularizing system 10 is implemented by the computing device 1. The computing device 1 further includes, but is not limited to, a storage device 11, and at least one processor 12. In one embodiment, the computing device 1 may be a personal computer (PC), a server or any other data processing device.

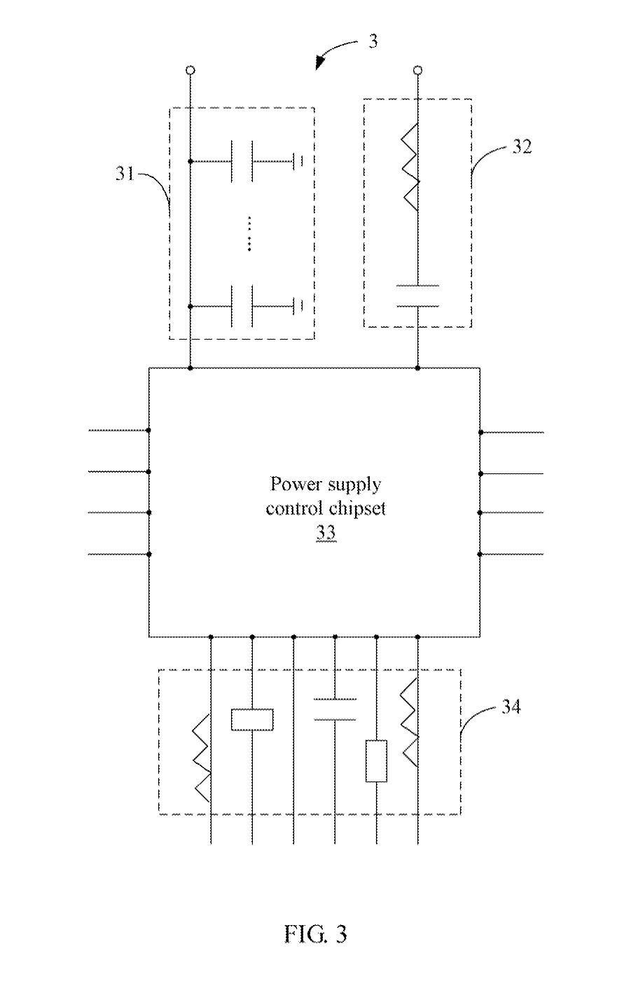

The computing device 1 connects to a database 2 that stores a plurality of circuit design drawings of power supplies, which may be placed on printed circuit boards (PCBs) when the PCBs are manufactured by a factory. FIG. 3 shows one embodiment of a circuit design drawing of a power supply 3. In the embodiment, the power supply 3 includes an input port 31, an output port 32, a control chipset 33, and a peripheral circuit 34. Each of the input port 31, the output port 32, and the peripheral circuit 34 is composed of one or more electronic components, such as resistor, capacitors, inductors, and transistors. The control chipset 33 connects to the input port 31, the output port 32, and the peripheral circuit 34, respectively. The control chipset 33 controls the power outputted from the power supply 3, and coordinates peripheral devices connected to the peripheral circuit 34 to work normally.

In one embodiment, the storage device 11 may be an internal storage system, such as a random access memory (RAM) for temporary storage of information, and/or a read only memory (ROM) for permanent storage of information. The storage device 11 may also be an external storage system, such as an external hard disk, a storage card, network access storage (NAS), or a data storage medium. The at least one processor 12 is a central processing unit (CPU) or microprocessor that performs various functions of the computing device 1.

In one embodiment, the power supply modularizing system 10 includes a component modularizing module 101, a component packet generating module 102, an information library creating module 103, and a layout implementing module 104. The modules 101-104 may comprise computerized instructions in the form of one or more programs that are stored in the storage device 11 and executed by the at least one processor 12. A description of each module is given in the following paragraphs.

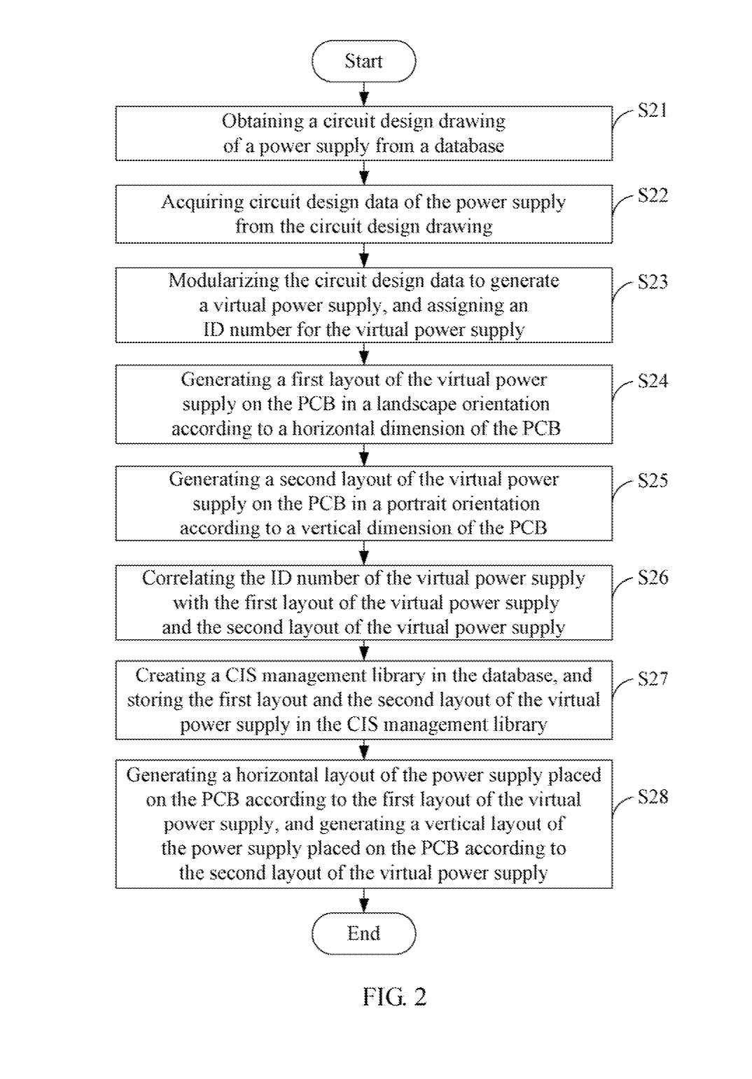

FIG. 2 is a flowchart of one embodiment of a method for modularizing power supplies placed on a PCB using the computing device 1 of FIG. 1. The method is performed by execution of computer-readable program codes or instructions stored in the storage device 11 and executed by the at least one processor 12. Depending on the embodiment, additional steps may be added, others removed, and the ordering of the steps may be changed.

In step S21, the component modularizing module 101 obtains a circuit design drawing of a power supply 3 from the database 2. In the embodiment, the power supply 3 may be placed on the PCB. The database 2 stores a plurality of circuit design drawings of power supplies that are placed on the PCB. For example, the circuit design drawing of the power supply 3 is shown in FIG. 3.

In step S22, the component modularizing module 101 acquires circuit design data of the power supply 3 from the circuit design drawing. Referring to FIG. 3, the circuit design data of the power supply 3 may include information of the input port 31, the output port 32, the control chipset 33, and the peripheral circuit 34. Each of the input port 31, the output port 32, and the peripheral circuit 34 is composed of one or more electronic components, such as resistor, capacitors, inductors, and transistors.

In step S23, the component modularizing module 101 modularizes the circuit design data to generate a virtual power supply, and assigns an identification (ID) number for the virtual power supply. For example, if a type of the power supply 3 is IR3842, the component modularizing module 101 modularizes the circuit design data of the power supply 3 to generate a virtual power supply 3, whose ID number is IR3842VRM.

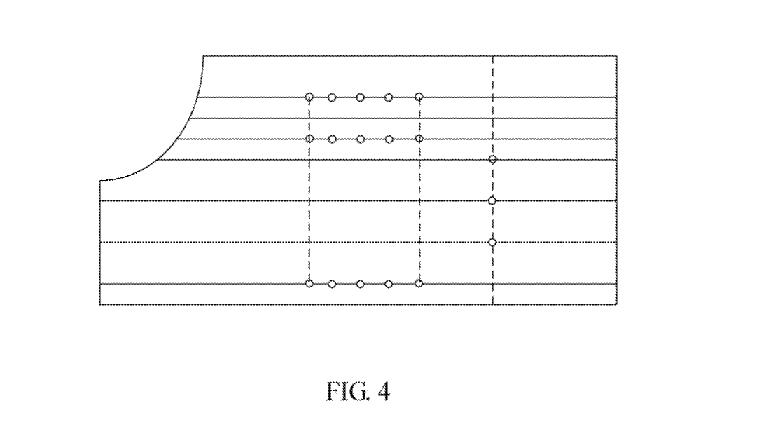

In step S24, the component packet generating module 102 generates a first layout of the virtual power supply on the PCB in a landscape orientation according to a horizontal dimension of the PCB. FIG. 4 shows a first layout of the virtual power supply placed on the PCB in the landscape orientation of the PCB. The first layout of the virtual power supply can be placed on the PCB based on the landscape orientation of the PCB. The horizontal dimension of the PCB is defined as a length dimension of the PCB and is measured horizontally.

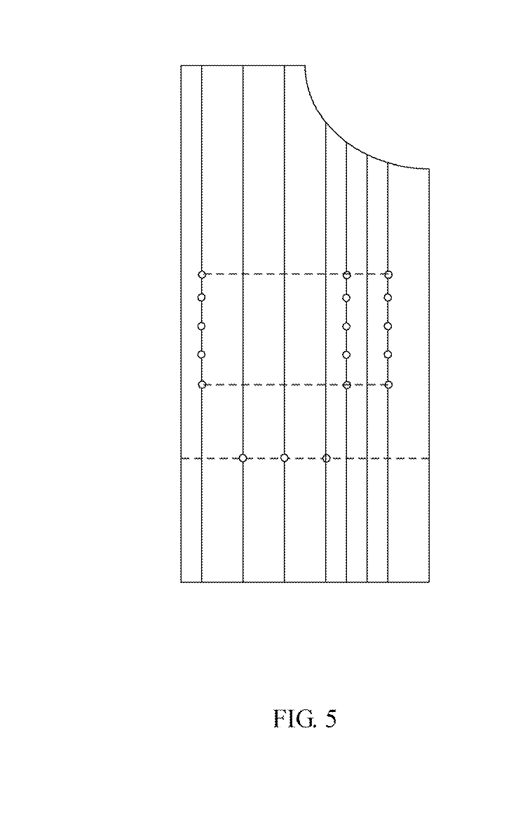

In step S25, the component packet generating module 102 generates a second layout of the virtual power supply on the PCB in a portrait orientation according to a vertical dimension of the PCB. FIG. 5 shows a second layout of the virtual power supply placed on the PCB in the portrait orientation of the PCB. The second layout of the virtual power supply can be placed on the PCB based on the portrait orientation of the PCB. The vertical dimension of the PCB is defined as a height dimension of the PCB measured vertically.

In step S26, the information library creating module 103 correlates the ID number of the virtual power supply 3 with the first layout of the virtual power supply and the second layout of the virtual power supply. In the embodiment, the ID number of the virtual power supply is related with two layouts of the power supply module, i.e., the first layout of the virtual power supply placed on the PCB in the landscape orientation, and the second layout of the virtual power supply placed on the PCB in the portrait orientation.

In step S27, the information library creating module 103 creates a component information system (CIS) management library in the database 2, and stores the first layout and the second layout of the virtual power supply in the CIS management library. In the embodiment, the CIS management library stores information of the layouts of the virtual power supply placed on the PCB, such as information of the input port 31, the output port 32, the control chipset 33, and the peripheral circuit 34 of the power supply 3.

In step S28, the layout implementing module 104 reads the first layout of the virtual power supply from the CIS management library according to the ID number of the virtual power supply when the power supply 3 is placed on the PCB in the landscape orientation, and generates a horizontal layout of the power supply 3 placed on the PCB according to the first layout of the virtual power supply. The layout implementing module 104 further reads the second layout of the virtual power supply from the CIS management library according to the ID number of the virtual power supply when the power supply 3 is placed on the PCB in the portrait orientation, and generates a vertical layout of the power supply 3 placed on the PCB according to the second layout of the virtual power supply.

In the present disclosure, since the different layouts of the power supply 3 are stored in the CIS management library of the database 2, the designer of the PCB can select a desired layout of the power supply 3 from the CIS management library, and easily and efficiently perform the placement of the power supply on the PCB.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
at least one processor; and
a storage device storing a computer-readable program including instructions that, which when executed by the at least one processor, causes the at least one processor to:
obtain a circuit design drawing of a power supply from a database connected to the computing device;
acquire circuit design data of the power supply from the circuit design drawing;
modularize the circuit design data to generate a virtual power supply, and assign an identification (ID) number for the virtual power supply;
generate a first layout of the virtual power supply on a printed circuit board (PCB) in a landscape orientation according to a horizontal dimension of the PCB;
generate a second layout of the virtual power supply on the PCB in a portrait orientation according to a vertical dimension of the PCB;
correlate the ID number of the virtual power supply with the first layout and the second layout of the virtual power supply; and
create a component information system (CIS) management library in the database, and store the first layout and the second layout of the virtual power supply in the CIS management library.

2. The computing device according to claim 1, wherein the computer-readable program further causes the at least one processor to:
read the first layout of the virtual power supply from the CIS management library according to the ID number of the virtual power supply; and
generate a horizontal layout of the power supply placed on the PCB according to the first layout of the virtual power supply when the power supply is placed on the PCB in the landscape orientation.

3. The computing device according to claim 1, wherein the computer-readable program further causes the at least one processor to:
read the second layout of the virtual power supply from the CIS management library according to the ID number of the virtual power supply; and
generate a vertical layout of the power supply placed on the PCB according to the second layout of the virtual power supply when the power supply is placed on the PCB in the portrait orientation.

4. The computing device according to claim 1, wherein the power supply comprises an input port, an output port, a control chipset, and a peripheral circuit, each of which comprising one or more electronic components including resistor, capacitors, inductors, and transistors.

5. The computing device according to claim 4, wherein the control chipset controls power outputted from the power supply, and coordinates peripheral devices connected to the peripheral circuit to work normally.

6. The computing device according to claim 1, wherein the horizontal dimension of the PCB is defined as a length dimension of the PCB measured horizontally, and the vertical dimension of the PCB is defined as a height dimension of the PCB measured vertically.

7. A method for modularizing power supplies placed on a printed circuit board (PCB) using a computing device, the method comprising:
obtaining a circuit design drawing of a power supply from a database connected to the computing device;
acquiring circuit design data of the power supply from the circuit design drawing;
modularizing the circuit design data to generate a virtual power supply, and assigning an identification (ID) number for the virtual power supply;
generating a first layout of the virtual power supply on the PCB in a landscape orientation according to a horizontal dimension of the PCB;
generating a second layout of the virtual power supply on the PCB in a portrait orientation according to a vertical dimension of the PCB;
correlating the ID number of the virtual power supply with the first layout and the second layout of the virtual power supply; and
creating a component information system (CIS) management library in the database, and storing the first layout and the second layout of the virtual power supply in the CIS management library.

8. The method according to claim 7, further comprising:
reading the first layout of the virtual power supply from the CIS management library according to the ID number of the virtual power supply; and
generating a horizontal layout of the power supply placed on the PCB according to the first layout of the virtual power supply when the power supply is placed on the PCB in the landscape orientation.

9. The method according to claim 7, further comprising:
reading the second layout of the virtual power supply from the CIS management library according to the ID number of the virtual power supply; and
generating a vertical layout of the power supply placed on the PCB according to the second layout of the virtual power supply when the power supply is placed on the PCB in the portrait orientation.

10. The method according to claim 7, wherein the power supply comprises an input port, an output port, a control chipset, and a peripheral circuit, each of which comprising one or more electronic components including resistor, capacitors, inductors, and transistors.

11. The method according to claim 10, wherein the control chipset controls power outputted from the power supply, and coordinates peripheral devices connected to the peripheral circuit to work normally.

12. The method according to claim 7, wherein the horizontal dimension of the PCB is defined as a length dimension of the PCB measured horizontally, and the vertical dimension of the PCB is defined as a height dimension of the PCB measured vertically.

13. A non-transitory storage medium having stored thereon instructions that, when executed by at least one processor of a computing device, cause the processor to perform a method for modularizing power supplies placed on a printed circuit board (PCB), the method comprising:
obtaining a circuit design drawing of a power supply from a database connected to the computing device;
acquiring circuit design data of the power supply from the circuit design drawing;
modularizing the circuit design data to generate a virtual power supply, and assigning an identification (ID) number for the virtual power supply;
generating a first layout of the virtual power supply on the PCB in a landscape orientation according to a horizontal dimension of the PCB;
generating a second layout of the virtual power supply on the PCB in a portrait orientation according to a vertical dimension of the PCB;
correlating the ID number of the virtual power supply with the first layout and the second layout of the virtual power supply; and
creating a component information system (CIS) management library in the database, and storing the first layout and the second layout of the virtual power supply in the CIS management library.

14. The storage medium according to claim 13, wherein the method further comprises:
reading the first layout of the virtual power supply from the CIS management library according to the ID number of the virtual power supply; and
generating a horizontal layout of the power supply placed on the PCB according to the first layout of the virtual power supply when the power supply is placed on the PCB in the landscape orientation.

15. The storage medium according to claim 13, wherein the method further comprises:
reading the second layout of the virtual power supply from the CIS management library according to the ID number of the virtual power supply; and
generating a vertical layout of the power supply placed on the PCB according to the second layout of the virtual power supply when the power supply is placed on the PCB in the portrait orientation.

16. The storage medium according to claim 13, wherein the power supply comprises an input port, an output port, a control chipset, and a peripheral circuit, each of which comprising one or more electronic components including resistor, capacitors, inductors, and transistors.

17. The storage medium according to claim 17, wherein the control chipset controls power outputted from the power supply, and coordinates peripheral devices connected to the peripheral circuit to work normally.

18. The storage medium according to claim 13, wherein the horizontal dimension of the PCB is defined as a length dimension of the PCB measured horizontally, and the vertical dimension of the PCB is defined as a height dimension of the PCB measured vertically.
